(19) United States
(12) Patent Application Publication
(10) Pub. No.: US 2003/0002943 A1
(43) Pub. Date: Jan. 2, 2003

(54) Method and device for detecting contact between a tool and a workpiece clamped on a processing machine

(76) Inventor: Dieter Ulbrich, Abstatt (DE)

Correspondence Address: THE GLEASON WORKS, 1000 UNIVERSITY AVENUE, P O BOX 22970, ROCHESTER, NY, 146922970

(21) Appl. No.: 10/146,561

(22) Filed: May 15, 2002

(30) Foreign Application Priority Data
Jun. 28, 2001 (DE) 101 31 312.8

(51) Int. Cl. B23F 1/00

(52) U.S. Cl. 409/1

(57) ABSTRACT

Method and device for determining contact between a tool and a workpiece clamped on a processing machine. A signal, such as a high-frequency electrical current signal or an acoustic signal, is supplied between a location at the tool and a location at the workpiece. For as long as the tool and the workpiece are not in contact with each other, the signal has a specific amplitude. As soon as the tool and the workpiece make contact with each other, the two locations are additionally connected through a resistor connected parallel to the resistance of the machine. Thereby the amplitude changes significantly. The process can be performed manually and automatically. It can also be employed at a quasi-standstill of tool and/or workpiece, but also when the elements are moving.

### FIELD OF THE INVENTION

The invention relates to a method and a device for detecting contact between a tool and a workpiece clamped on a processing machine.

### BACKGROUND OF THE INVENTION

For finishing the tooth surfaces of pre-toothed workpieces, tool and workpiece must be brought into a contact position such that for dual-flank machining the “center of a tool tooth” is aligned with the “center of a workpiece tooth space”.

A well-known method for solving this object resides in that the tool and the workpiece are moved toward each other to such an extent that the tool enters with one tooth or several teeth, depending on the type of tool, into one or several tooth spaces of the workpiece and that the distance of the flanks of both elements is subsequently reduced by a relative movement, for example, a rotating movement of the tool or the workpiece, to such an extent that the flanks come into contact with each other. The position of the first contact is stored. Subsequently, the sign of the relative movement is reversed and the first contact of the counter flanks is determined. The center point between these two positions is the centering position. It is desirable to know this centering position with micrometer precision (relative to the tool circumference or workpiece circumference). For this purpose, the first contact must be determined reliably and precisely. Since during the advancement between the tool and the workpiece the tooth of the tool is not necessarily positioned opposite a space of the workpiece and, in particular, for automatically performed contact determination, the tip of the tool tooth may impact the tip of the workpiece tooth, this first contact must also be evaluatable in a reliable way.

The desire to reliably determine the first contact between a tool and a workpiece exists also outside of the area of machining of toothed wheels, for example, in milling of high-precision workpieces, particularly in cases in which the machining process occurs at contact locations which are difficult to access or are not visible.

Various methods are known for determining the first contact when positioning a tool for a metal-removing process.

Methods using a light slit are not sufficiently precise and practically cannot be automated, in particular, in the case of difficult-to-access contact locations.

Methods based on measuring and evaluating forces between tool flank and workpiece flank, moments about the rotational tool axis or rotational workpiece axis, solid-borne sound due to the friction between the tool flank and the workpiece flank require as a prerequisite that, after contact has occurred, first a satisfactory prestress of the system must be provided in order to obtain signals having a sufficiently large spacing from unavoidable, process-related interfering signals. This prestress can even result in workpiece surfaces already being clearly machined locally. Therefore, such principles are ruled out for high-precision requirements. Furthermore, the method of evaluating solid-borne sound signals resulting from the friction between the tool and the workpiece has the disadvantage that it cannot be employed in a quasi-standstill operation because no signals occur that may be evaluated in a meaningful way. What is meant by a quasi-standstill is a very slow advancing movement or a step-wise advancing movement of, for example, 1 μm, with no overlaying cutting motion in either case.

In another well-known method the contact is to be determined by direct-current or direct-voltage signals. For this purpose, the two poles of the source are connected with the tool or with a location in the vicinity of the tool and with the workpiece or a location in the vicinity of the workpiece and the voltage between the two poles is measured. In this case, an electric connection exists between the poles via the machine and upon contact between the tool and the workpiece an additional connection exists through the contact location. As long as the electric resistance via the contact location is very small, compared to the resistance through the machine, the contact can be reliably determined. However, the problem in this connection is that the direct-current resistance between the mechanical machine elements may vary in an undefined way between almost infinite and very small values up to the magnitude of the transition resistance at contact between the workpiece and the tool. A reliable evaluation is not possible in this way. Low resistance values cause high currents and this can cause corrosion problems, for example, in bearings. A complete electrical isolation of tool axis and workpiece axis can only be achieved at high costs, especially in the case of workpieces or machines of medium or large dimensions.

The object following from the facts as discussed above is to develop a method and a device for detecting the first contact on positioning a tool relative to the workpiece, wherein both elements are received on a machine tool in such a way as during the machining process itself. The method should be simple and operate reliably and with high precision. Manual operation should be possible, but also an automated operation. Operation should be possible in a quasi-standstill position, but also when one element is moved, for example, a milling cutter, or when both elements are rotated, as, for example, in continuously operating gear cutting processes. Finally, it should also operate reliably when the contact occurs at contact locations which are difficult to access or not visible, as is the case, for example, with gear shaping of internal toothings.

### SUMMARY OF THE INVENTION

According to the inventive method a high-frequency electrical current signal is employed as the signal. The corresponding device has the signal source which supplies the high-frequency electrical current signal and whose internal resistance is high in comparison to the resistance of the machine between the two connecting points. The signal supplied between the connecting points is supplied to the evaluation device which evaluates this signal and sends an output signal to the machine control for further processing.

In an alternative inventive method an acoustic signal is used as a signal. Accordingly, the device used for performing this method has the sound source which supplies the acoustic signal and the sound receiver which receives the acoustic signal and transforms it into an electrical signal. The electrical signal is supplied to an evaluation device which evaluates the signal and sends a corresponding output signal to the machine control for further processing.

The invention, and further features thereof, will be explained in more detail below and with the aid of the drawings.

### BRIEF DESCRIPTION OF THE DRAWINGS

FIG. 1 illustrates a schematic view of a gear-shaping machine as an example of a machine tool, with a tool and a workpiece, for explaining the inventive method

FIG. 2 shows a circuit diagram of a machine tool according to FIG. 1 and an example of a first embodiment of an inventive device.

FIG. 3 shows a circuit diagram of a machine tool according to FIG. 1 and an example of a second embodiment of an inventive device.

### DETAILED DESCRIPTION OF THE PREFERRED EMBODIMENTS

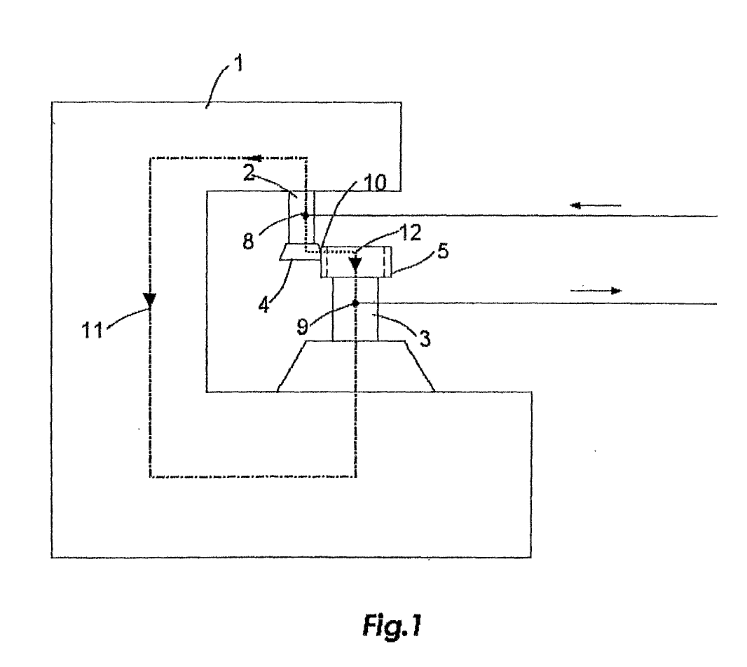

In the case of a gear-shaping machine 1 according to FIG. 1 having a tool spindle 2, a workpiece spindle 3, a tool 4, and a pre-toothed workpiece 5, the first contact is to be determined, for example, during the course of positioning the tool 4 relative to the workpiece 5.

In a first embodiment, a high-frequency electrical signal is supplied between the locations 8 and 9 at the tool spindle 2 and the workpiece spindle 3, or, in a second embodiment, a solid-borne sound source or a solid-borne sound receiver is connected to location 8 and a solid-borne sound source or a solid-borne sound receiver to location 9. A signal path 11 via the machine (high resistance) exists between locations 8 and 9, as long as no contact has yet occurred between the tool 4 and the workpiece 5. When contact occurs between the tool 4 and the workpiece 5, a signal path 12 (small resistance) is present. As long as no contact occurs between the tool 4 and the workpiece 5, the signal path 12 is interrupted at the contact location 10. In this case, a specific voltage is present between locations 8 and 9 or a specific solid-borne sound level at the signal receiver. As soon as contact occurs between the tool 4 and the workpiece 5, the signal path 12 is activated, the respective signal changes very significantly due to the small resistance connected in parallel. This signal change can easily be evaluated as a contact-detection signal. Resistance in this instance means the electrical resistance as well as the sound resistance.

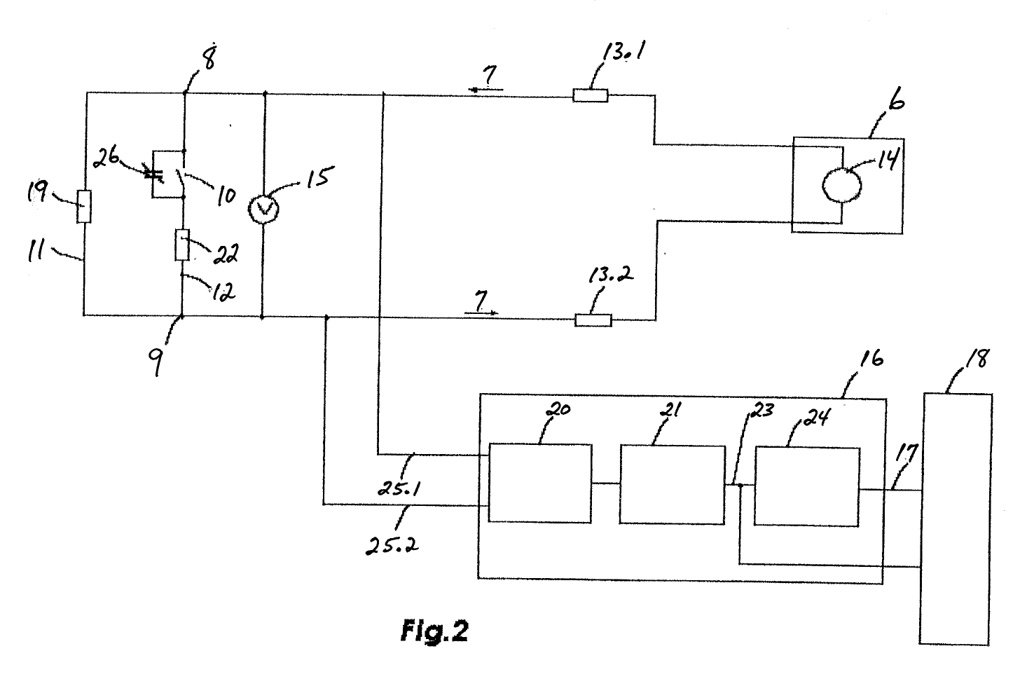

In the first embodiment (FIG. 2) a high-frequency electrical signal (for example, starting at 2 MHz) is employed between a location 8 at the tool 4 or in the vicinity thereof and a location 9 at the workpiece 5 or in the vicinity thereof and the voltage is measured between these locations. As long as no contact occurs between the tool 4 and the workpiece 5, the connection between these locations 8, 9 only exists via the path 11 of the machine 1. The resistance is high for the high-frequency signal. Upon contact between the tool 4 and the workpiece 5, a low resistance, essentially via the contact location 10 and parts of the tool 4, tool spindle 2, workpiece 5, and workpiece spindle 3, is connected parallel to the high resistance via the machine 1. This results in a high voltage drop for a corresponding internal resistance of the signal source. This voltage drop occurs without any significant force at the contact location 10. The signal can be easily evaluated.

Advantages of using high-frequency electrical signals include:

High frequency bridges (capacitively) an electrical isolation. This can sometimes occur in the case of bearings, guide paths etc., particularly when these elements are moved.

The coupled mechanical elements constitute a relatively uniform and high impedance (predominantly inductive) for the high frequency. As a result, the signal change upon contact between the tool and the workpiece can be evaluated reliably and easily.

High frequency permits a frequency-selective evaluation whereby the signal-to-background ratio is increased.

High frequency allows in a simple way (capacitively) the coupling of the signals of stationary machine elements into moving ones. The same applies to decoupling of the signals from moving machine elements to stationary ones.

In FIG. 2, the left portion shows the equivalent circuit diagram of the machine tool according to FIG. 1 and in its right portion it shows an example of the configuration of a device for detecting the contact. The locations 8 and 9 are connected to a resistor 19 via the signal path 11 and via the signal path 12 to a resistor 22 and to a switch formed by the contact location 10. This switch is initially open during positioning of the tool 4. The switch is closed upon contact between the tool 4 and the workpiece 5. A unit 6 generates a high-frequency signal 7. Due to the internal resistance of a signal source 14 of unit 6, divided into the individual resistors 13.1 and 13. 2, which resistance should be significantly greater than that of the complex resistor 19 of the signal path 11, a signal 15 with a corresponding amplitude is created at the input locations 8 and 9 because of the resistor 19 of the path 11. When contact occurs, the amplitude of the signal 15 changes significantly because of the contact 10 when the complex resistor 22 of the path 12 is significantly smaller than the one of the path 11. This condition is met when contact occurs.

The course of the signal amplitude shortly before contact occurs is not abrupt, due to the building capacity 26 positioned parallel to the switch 10. With certain contact surfaces, an approaching position can already be observed in the μm-range.

In the vicinity of the locations 8 and 9, the signals 25.1 and 25.2 are tapped and supplied to a frequency-selective measuring receiver 20 of a signal evaluation device 16. The receiver feeds an evaluation unit 21 which evaluates the measuring signal according to value and/or phase and supplies it as an analog signal 23 to a comparator 24. The digital output signal 17 is supplied to the machine control 18. There, the movement of the axes of the machine tool 1 is controlled in a suitable and well-known manner. Also, the analog signal 23 from the evaluation unit 21 can additionally be supplied to the machine control 18 in order to already evaluate an approaching position. This makes it possible to operate at a higher positioning speed until shortly before contact occurs and to perform the process of contact detection in a shorter time.

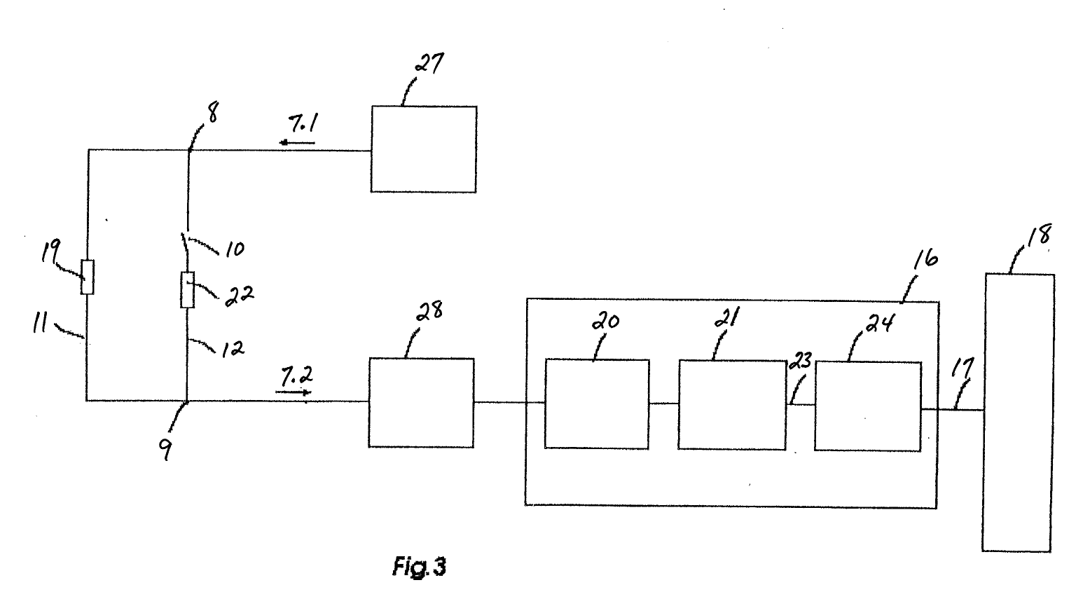

According to another embodiment as shown in FIG. 3, a solid-borne sound source 27 is arranged at the location 8 on the tool 4 or in the vicinity thereof and a solid-borne sound receiver 28 is arranged at the location 9 on the workpiece 5 or in the vicinity thereof.

The signal 7.1 can be in the ultrasound range. As long as no contact occurs between the tool 4 and the workpiece 5, for the sent solid-borne sound signal 7.1 there is only a connection between the locations 8 and 9 through the machine 1 via the path 11 and the solid-borne sound resistor 19. The resistance of the solid-borne sound resistor 19 is high on this path, the received signal 7.2 is low. Upon contact between the tool 4 and the workpiece 5, a significantly lower solid-borne sound resistance 22, essentially created by the contact location 10 and parts of the tool 4, the tool spindle 2, the workpiece 5, and the workpiece spindle 3, is connected parallel to the high resistance through the machine 1. This results in a strong increase of the solid-borne sound signal 7.2 at the receiver 28. This increase occurs without any significant force at the contact location; the signal can be easily evaluated. For increasing the signal-to-background ratio the evaluation can be realized through the frequency-selective measuring receiver 20. This receiver supplies the evaluation unit 21, which evaluates the measuring signal according to value and/or phase and supplies it as an analog signal 23 to the comparator 24. The digital output signal 17 is supplied to the machine control 18. There, the movement of the axes of the machine is controlled in a suitable and well-known manner.

The proposed method and the proposed device for determining contact between a tool and a workpiece can be utilized not only during the positioning process but also during machining. This makes it possible to move through the contact-free paths at a high advancing or feed speed and to switch to machining speed when contact occurs.

While the invention has been described with reference to preferred embodiments it is to be understood that the invention is not limited to the particulars thereof. The present invention is intended to include modifications which would be apparent to those skilled in the art to which the subject matter pertains without deviating from the spirit and scope of the appended claims.

What is claimed is:

1. A method for determining contact between a tool (4) and a workpiece (5) clamped on a metal-removing processing machine (1), said method comprising:
moving said tool and said workpiece relatively toward one another,
supplying a signal between a location (8) on the tool (4) or in the vicinity thereof and a location (9) on the workpiece (5) or in the vicinity thereof, said signal having a first amplitude due to the connection of the two locations (8, 9) via a signal path (11) of the machine (1) and the resistance (19) effective across the signal path for as long as there is no contact between the tool (4) and the workpiece (5), said signal changing to a second amplitude as said two locations (8, 9) are additionally connected upon contact between the tool (4) and the workpiece (5) via a resistor (22) connected parallel to the resistance (19) of the machine (1), wherein a high-frequency electrical current signal is employed as the signal.

2. The method of claim 1 wherein a high-frequency electrical current signal with a constant frequency is employed as the signal.

3. The method of claim 2 wherein the change from the first to the second amplitude of said high-frequency electrical current signal is evaluated frequency-selectively.

4. The method of claim 1 wherein the signal is transmitted capacitively to moving parts of the machine (1) and/or tapped capacitively from moving parts of the machine (1).

5. The method of claim 1 further comprising:
supplying an analog output signal (23) to an evaluation unit (21) of a control (18),
evaluating said output signal at said evaluation unit as an approach signal,
adjusting the advancing speed of the relative movement of said tool and workpiece in response to the evaluated output signal.

6. Method for determining contact between a tool (4) and a workpiece (5) clamped on a machine (1) for processing toothed workpieces, said method comprising:
moving said tool and said workpiece relatively toward one another,
supplying a signal at one of (a) a location (8) on the tool (4) or in the vicinity thereof, or (b) at a location (9) on the workpiece (5) or in the vicinity thereof,
receiving said signal at the other of (a) a location (8) on the tool (4) or in the vicinity thereof, or (b) at a location (9) on the workpiece (5) or in the vicinity thereof, the signal having a specific amplitude due to the connection of the two locations (8, 9) via the signal path (11) of the machine (1) and the resistance (19) effective across this connection, for as long as there is no contact between the tool (4) and the workpiece (5),
whereby upon contact between the tool (4) and the workpiece (5) the signal changes in its amplitude as said two locations (8) and (9) are additionally connected through the contact via a resistor (22) connected parallel to the resistance (19) of the machine (1),
wherein an acoustic signal is employed as the signal.

7. The method of claim 6 wherein the acoustic signal is a solid-borne sound signal.

8. The method of claim 7 wherein a solid-borne sound signal with a constant frequency is used as the signal.

9. The method of claim 6 wherein the change in amplitude of the acoustic signal is evaluated frequency-selectively.

10. The method of claim 6 wherein the acoustic signal is supplied at one location (9) and is received at the other location (8).

11. The method of claim 6 wherein the acoustic signal is supplied at one location (8) and is received at the other location (9).

12. A device for determining contact between a tool (4) and a workpiece (5) on a workpiece processing machine (1) wherein the device comprises:
at least one signal source (14) which supplies a high-frequency electrical signal and whose internal resistance is high in comparison to the resistance (19) of a signal path (11) of the machine (1) between two connecting locations (8, 9), the signal being supplied between the connecting locations (8, 9) to an signal evaluation device (16) which evaluates the signal and supplies an output signal (17) to a machine control (18) for further processing.

13. The device of claim 12 wherein the signal evaluation device (16) is provided with a frequency-selective measuring receiver (20) having arranged downstream thereof an evaluation unit (21).

14. The device of claim 13 wherein the evaluation unit (21) evaluates the signals supplied by the measuring receiver (20) according to value and/or phase.

15. The device of claim 12 wherein the evaluation unit (21) has a comparator (24) arranged downstream thereof.

16. The device of claim 15 wherein the comparator (24) supplies signals (17) to the machine control (18) for further processing.

17. The device of claim 12 wherein the output of the evaluation unit (21) is directly connected with the control (18).

18. A device for determining contact between a tool (4) and a workpiece (5) on a workpiece processing machine (1), said device comprising:
at least one sound source (27) which supplies an acoustic signal and whose internal resistance is low in comparison to the resistance (19) of the machine (1) between the contact locations (8) and (9),
at least one sound receiver (28) which receives a signal at the contact location (9), transforms it into an electrical signal and supplies it to an evaluation device (16) which evaluates the signal and supplies an output (17) to a machine control (18) for further processing.

19. The device of claim 18 further comprising said evaluation device (16) being provided with a frequency-selective measuring receiver (20) having arranged downstream thereof an evaluation unit (21).

20. The device of claim 19 where in the evaluation unit (21) evaluates the signals supplied by the measuring receiver (20) according to value and/or phase.

21. The device of claim 18 wherein evaluation unit (21) has a comparator (24) arranged downstream thereof.

22. The device of claim 21 wherein the comparator (24) supplies signals (17) to the machine control (18) for further processing.

23. The device according to claim 18 wherein the sound source (27) is connected to one connecting location (9) and the sound receiver (28) is connected to the other connecting location (8).

24. The device according to claim 18 wherein the sound source (27) is connected to one connecting location (8) and the sound receiver (28) is connected to the other connecting location (9).
